(19) United States
(12) Patent Application Publication
(10) Pub. No.: US 2021/0155263 A1
(43) Pub. Date: May 27, 2021

(54) AUTONOMOUS VEHICLE AND METHOD FOR AUTONOMOUS DRIVING CONTROL USING THE SAME

(71) Applicant: LG ELECTRONICS INC., Seoul (KR)

(72) Inventors: Namyong PARK, 06772 (KR); Kwanghee LEE, Seoul (KR)

(21) Appl. No.: 16/921,383

(22) Filed: Jul. 6, 2020

(30) Foreign Application Priority Data
Nov. 25, 2019 (KR) 10-2019-0152575

(51) Int. Cl. B60W 60/00; B60W 40/08; B60W 30/18; B60W 10/30

(52) U.S. Cl. CPC B60W 60/0013; B60W 40/08; B60W 30/18163; B60W 2552/10; B60W 2540/22; B60W 2040/0809; B60W 2540/221; B60W 10/30

(57) ABSTRACT

An autonomous driving control method according to an embodiment of the present disclosure includes identifying the passenger by monitoring an interior of the vehicle, verifying stress of the passenger, based on that a processor checks a stress history of the passenger or senses biometric information of the passenger in real time, determining a cause of the stress by the processor, based on that the stress of the passenger is verified, and controlling an autonomous driving mode or an autonomous driving level of the vehicle by the processor, based on the cause of the stress. One or more of an autonomous vehicle, a user terminal, and a server of the present disclosure may be in conjunction with an Artificial Intelligence (AI) module, an Unmanned Aerial Vehicle (UAV), an Augmented Reality (AR) device, a Virtual Reality (VR) device, and a device related to a 5G service, etc.

### CROSS-REFERENCE TO RELATED APPLICATIONS

This application claims the benefit of Korea Patent Application No. KR2019/0152575, filed on Nov. 25, 2019, the contents of which are hereby incorporated by reference herein in their entirety.

### BACKGROUND

### Field of the Disclosure

The present disclosure relates to an autonomous vehicle and an autonomous driving control method using the same.

### Related Art

Vehicles may be classified into internal combustion engine vehicles, external combustion engine vehicles, gas turbine vehicles, electric vehicles, etc.

Recently, development of an autonomous vehicle capable of driving on its own with partially or entirely excluding manipulation of a driver has been actively ongoing.

Various systems are being introduced into the autonomous vehicle to ensure the safety and comfort of passengers.

### SUMMARY

The present disclosure aims to address the aforementioned problem.

The present disclosure provides an autonomous vehicle and an autonomous driving control method capable of performing safe driving regardless of a passenger's stress.

Furthermore, the present disclosure provides an autonomous vehicle and an autonomous driving control method capable of more accurately and efficiently ensuring a passenger's safety and alleviating a passenger's stress according to the type and cause of the passenger's stress.

In an aspect, an autonomous driving control method is intended to control a driving mode based on that a passenger getting on a vehicle is monitored. The method may include identifying the passenger by monitoring an interior of the vehicle, verifying stress of the passenger, based on that a processor checks a stress history of the passenger or senses biometric information of the passenger in real time, determining a cause of the stress by the processor, based on that the stress of the passenger is verified, and controlling an autonomous driving mode or an autonomous driving level of the vehicle by the processor, based on the cause of the stress.

The controlling of the autonomous driving mode may select any one of preset autonomous driving levels, based on that the passenger holds a first type of stress verified in advance.

The selecting of the autonomous driving level may set the autonomous driving level to level 3 or more, based on that a stress value of the passenger is equal to or greater than a first threshold value.

The setting of the autonomous driving level to level 3 or more may include:

retrieving information about an expected driving path by the processor, predicting variance of the passenger's biometric information, based on that variance of biometric information of the passenger or other passengers on the expected driving path is learned, and setting the autonomous driving level to level 3 or more by the processor, based on that the predicted variance of the biometric information exceeds a preset safety range.

The sensing of the biometric information may control a sensing unit by the processor at predetermined sensing interval while driving, based on that a stress level of the passenger is less than the preset first threshold value.

The controlling of the autonomous driving mode may include verifying an emergency situation of the passenger by the processor, based on that the biometric information exceeds the preset safety range, and setting the autonomous driving level to level 3 or more by the processor, based on the emergency situation.

The sensing of the biometric information may set a sensing interval differently according to the stress level.

The verifying of the stress of the passenger may include verifying a second type of stress of a driver by the processor, based on that the biometric information exceeds the preset safety range.

The controlling of the autonomous driving mode may further include verifying, by the processor, an event causing the second type of stress before a predetermined time from a time when the second type of stress occurs, based on that the second type of stress is verified.

The controlling of the autonomous driving mode may further include controlling a driving device to change a lane of a host vehicle by the processor, based on the event in which a number of lane changes or sudden stops of a preceding vehicle is equal to or greater than a preset threshold value during a reference time.

The controlling of the autonomous driving mode may further include controlling an audio system by the processor, based on the event in which a surrounding noise of the host vehicle is equal to or greater than a preset threshold value.

The controlling of the autonomous driving mode may further include controlling the driving device to change the lane of the host vehicle or stop on a shoulder by the processor, based on the event in which an illuminance caused by a headlight of a vehicle following the host vehicle is equal to or greater than a preset threshold value.

In another aspect, an autonomous vehicle is provided. The autonomous vehicle may include a driving device, an autonomous driving system configured to control a portion or entirety of the driving device according to an autonomous driving level, an object detection device configured to acquire a surrounding image, a sensing unit configured to acquire biometric information of a passenger, a surrounding noise, an illuminance and the like, and a processor configured to verify presence or absence of a passenger's stress on the basis of a server inquiry or the biometric information, and to control an autonomous driving mode on the basis of the passenger's stress.

The processor may adjust an autonomous driving level, based on that the passenger is a person having a first type of stress verified in advance.

The processor may set the autonomous driving level to level 3 or more, based on that a stress value of the passenger is equal to or greater than a first threshold value.

The processor may retrieve information about a driving path when the stress value of the passenger is equal to or greater than the first threshold value, and may set the autonomous driving level to level 3 or more when the passenger's stress is expected on the driving path.

The processor may sense the biometric information of the passenger, based on that a stress level of the passenger is less than a first threshold value, and may set the autonomous driving level to level 3 or more, based on that the biometric information exceeds a preset safety range.

The processor may verify a second type of stress verified in real time, based on that the biometric information of the passenger exceeds the preset safety range during driving, verify an event causing acute stress before a predetermined time from a time when the second type of stress is verified, and set the autonomous driving level in response to the event.

According to the present disclosure, safer driving can be performed by controlling an autonomous driving level and an autonomous driving mode depending on the presence or absence of a passenger's stress.

Further, according to the present disclosure, it is possible to more accurately and efficiently ensure a passenger's safety and alleviate a passenger's stress, by controlling autonomous driving according to the type and cause of the passenger's stress.

### BRIEF DESCRIPTION OF THE DRAWINGS

FIG. 1 shows an exemplary block diagram of a wireless communication system to which methods proposed in the present specification is applicable.

FIG. 2 shows an example of a method of transmitting and receiving signals in a wireless communication system.

FIG. 3 shows an example of basic operations between an autonomous vehicle and a 5G network in a 5G communication system.

FIG. 4 shows an example of basic operations between one vehicle and another vehicle using 5G communications.

FIG. 5 is a diagram showing a vehicle according to an embodiment of the present disclosure.

FIG. 6 is a control block diagram of a vehicle according to an embodiment of the present disclosure.

FIG. 7 is a control block diagram of an autonomous driving device 100 according to an embodiment of the present disclosure.

FIG. 8 is a signal flowchart of an autonomous vehicle according to an embodiment of the present disclosure.

FIG. 9 is a diagram showing an autonomous driving system according to an embodiment of the present disclosure.

FIG. 10 is a diagram showing an autonomous vehicle according to an embodiment of the present disclosure.

FIG. 11 is a flowchart showing an autonomous driving control method according to an embodiment of the present disclosure.

FIG. 12 is a flowchart showing an embodiment of determining the stress type of a passenger (USER).

FIG. 13 is a flowchart illustrating an embodiment of setting an autonomous driving level according to a first type of stress level.

FIG. 14 is a flowchart illustrating another embodiment of controlling an autonomous driving mode.

FIG. 15 is a flowchart illustrating an embodiment of controlling autonomous driving according to a stress cause.

FIG. 16 is a diagram illustrating a specific embodiment of controlling autonomous driving according to an event occurrence.

### DETAILED DESCRIPTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

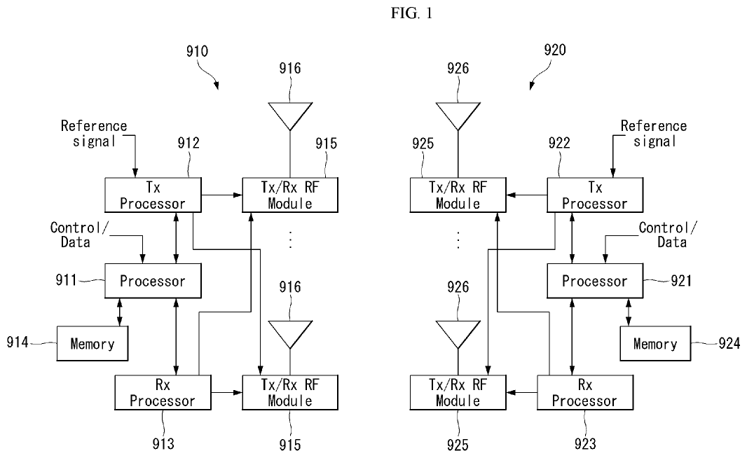

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

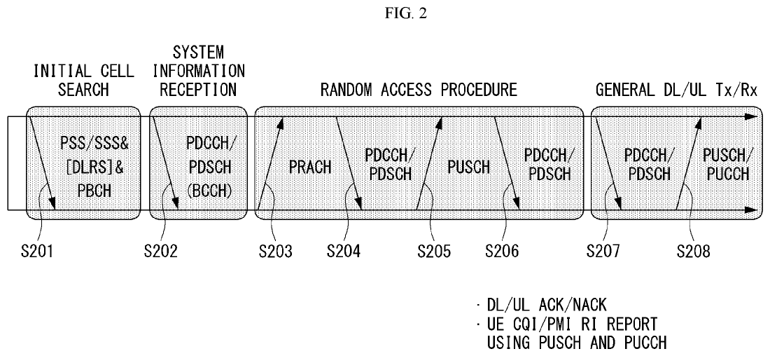

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to verify a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (System InformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE verifys whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.
When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to “beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

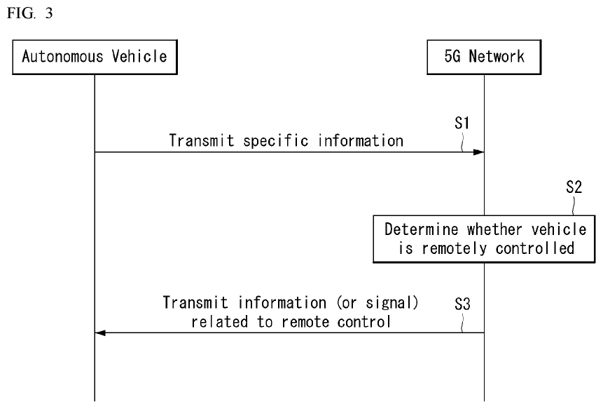

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

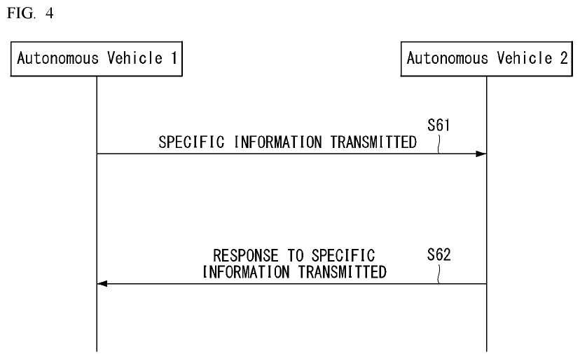

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

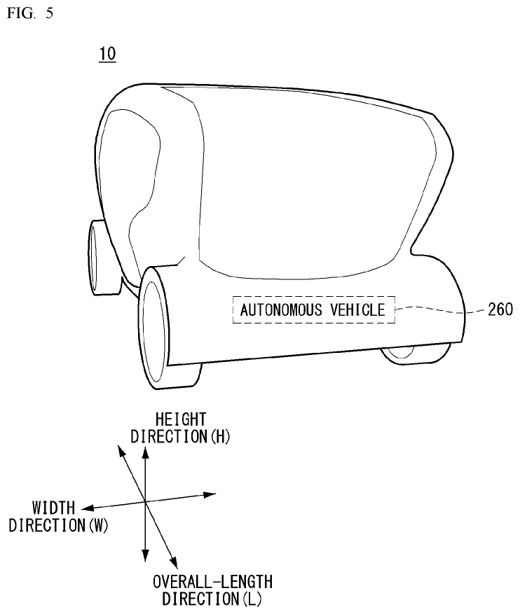

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

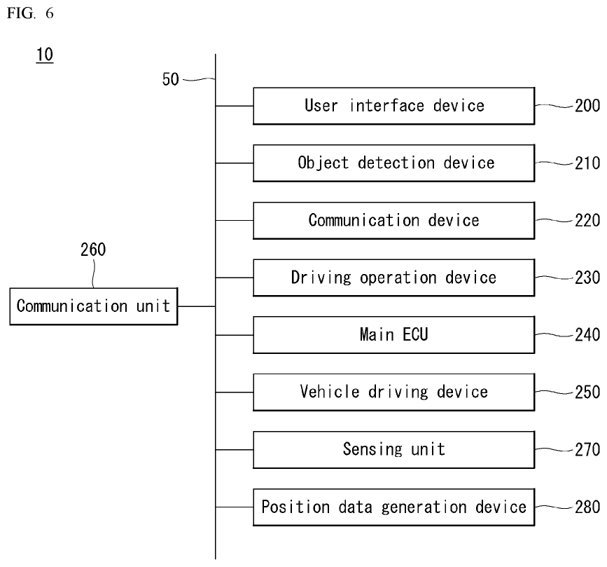

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a path for self-driving on the basis of acquired data. The autonomous device 260 can generate a driving plan for traveling along the generated path. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

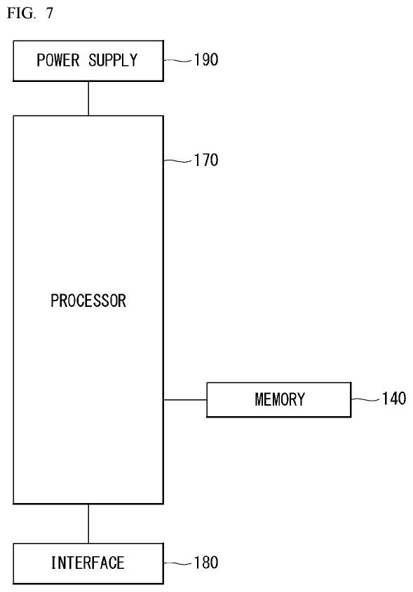

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

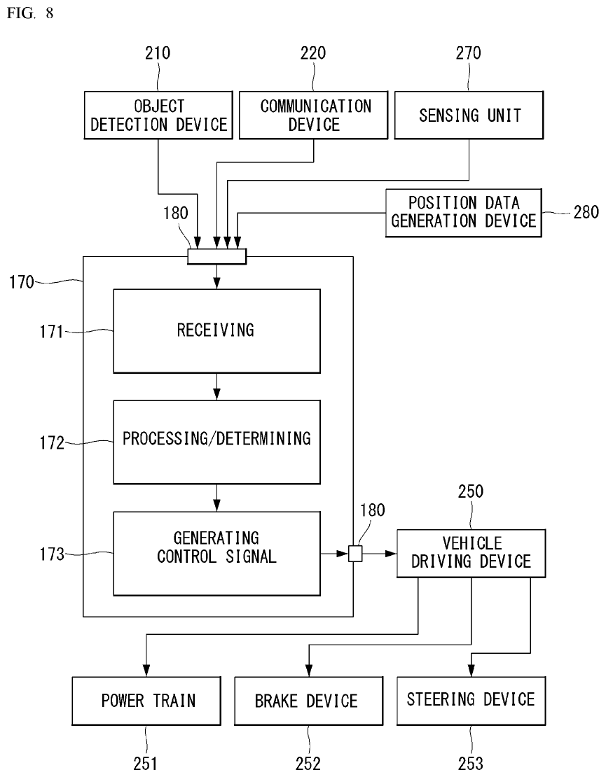

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling path. The horizon may refer to a point at which the vehicle can arrive after a predetermined time from the position at which the vehicle 10 is located along a predetermined traveling path.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

The above-mentioned 5G communication technology may be applied in combination with methods proposed in the present disclosure that will be described later, or be supplemented to implement or clarify the technical features of the methods proposed in the present disclosure.

Hereinafter, various embodiments of the present disclosure will be described in detail with reference to the accompanying drawings.

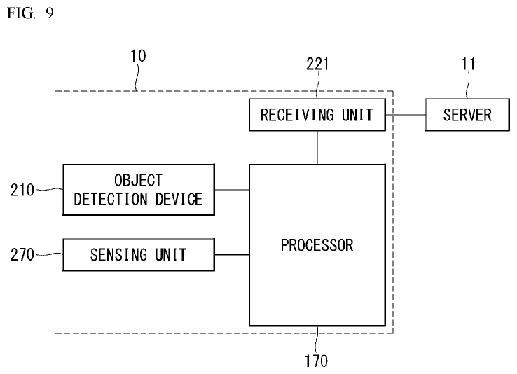

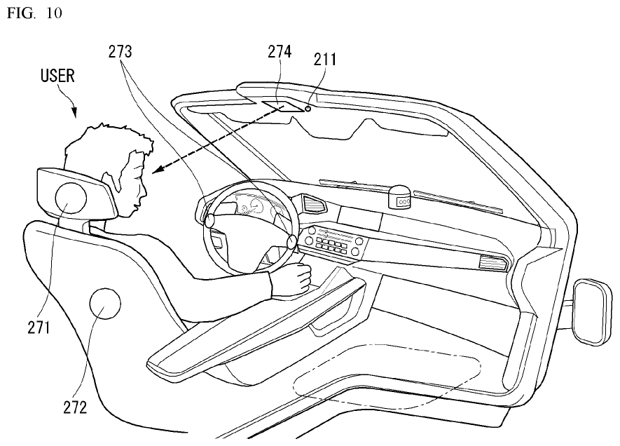

FIG. 9 is a diagram showing an autonomous driving system according to an embodiment of the present disclosure. FIG. 10 is a diagram showing an autonomous vehicle according to an embodiment of the present disclosure.

Referring to FIGS. 9 and 10, the autonomous driving system according to the embodiment of the present disclosure includes a vehicle 10 and a server 11.

The server 11 may correspond to an external server that manages the record of a passenger's health examination, and may be a server managed in a hospital, for example. The server 11 manages the presence of the chronic stress held by the passenger and the chronic stress level of the passenger. The chronic stress refers to a first type of stress that is previously verified through at least one of a physiological test and a psychological test, and may be numerically expressed in proportion to a stress level.

As described with reference to FIG. 6, the vehicle 10 may include an object detection device 210, a sensing unit 270, a receiving unit 221, and a processor 170. As illustrated in FIG. 10, the object detection device 210 may include a camera 211 that photographs a user to acquire a 2D or 3D image. As illustrated in FIG. 10, the sensing unit 270 may include first to fourth sensors 271 to 274. The first sensor 271 may be a head sensor that is disposed on a headrest of a driver's seat and is in contact with the head of a passenger USER. The first sensor 271 may include one or more sensors to detect the cerebral blood flow, body temperature, and impulse of the passenger USER. The second sensor 272 may be a sensor that is disposed on a backrest of the driver's seat or a safety belt to sense the posture of the passenger USER or measure a heart rate. The third sensor 273 may be a sensor that is disposed on a steering wheel to measure the pulse and body temperature of the passenger USER. A fourth sensor 274 may be a non-contact sensor such as a body temperature sensor.

The processor 170 verifies the stress of the passenger and controls the autonomous driving according to the type or cause of the stress. The processor 170 may perform the autonomous driving mode or the autonomous driving control according to the stress cause of the passenger USER, by analyzing an event before a predetermined time from a time when the stress of the passenger is sensed and then determining the stress. The processor 170 according to the present disclosure can more reliably perform the autonomous driving, in contrast to controlling control specific driving simply based on the presence or absence of the passenger's stress.

Hereinafter, various embodiments in which the autonomous vehicle according to an embodiment of the present disclosure controls autonomous driving according to a passenger's stress will be described.

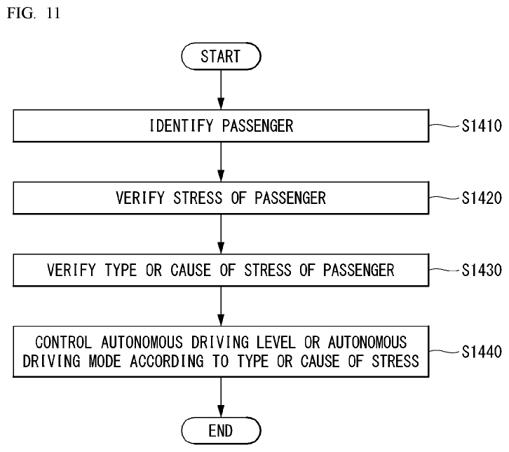

FIG. 11 is a flowchart showing an autonomous driving control method according to an embodiment of the present disclosure.

Referring to FIG. 11, the autonomous driving control method according to the embodiment of the present disclosure identifies the passenger USER at a first step S1410. The passenger USER may correspond to all persons getting on the vehicle, and particularly refers to a person who sits in the driver's seat and has an authority to be involved in driving the vehicle according to the autonomous driving level.

It is possible to acquire the image of the passenger USER using the object detection device 210 such as the camera 211. The processor 170 may identify the passenger USER on the basis of the image of the passenger USER. In addition, the object detection device 210 may acquire various pieces of information about the passenger USER, and the processor 170 may identify the passenger USER on the basis of the information acquired by the object detection device 210.

At a second step S1420 and a third step S1430, the stress of the passenger USER is verified. Moreover, the type and cause of the stress is verified. The type of the stress may be classified into chronic stress that is a first type and acute stress that is a second type. The processor 170 may verify the chronic stress of the passenger by retrieving the server to check the stress history of the passenger. Furthermore, the processor 170 may verify the acute stress of the passenger, based on that the biometric information of the passenger is sensed in real time. As such, the processor 170 determine whether the cause of the stress is chronic or is due to surrounding vehicles or surrounding environment.

At a fourth step S1440, the processor 170 may control the autonomous driving level or the autonomous driving mode according to the type or cause of the stress. The autonomous driving level may be divided into six levels from “level 0” to “level 5” as defined by Society of Automotive Engineers (SAE).

Hereinafter, embodiments of respective steps shown in FIG. 11 will be described.

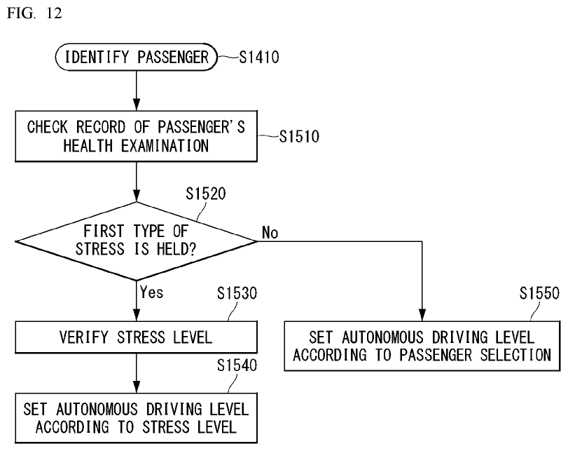

FIG. 12 is a flowchart showing an embodiment of determining the stress type of the passenger USER.

Referring to FIG. 12, the processor 170 that identifies the passenger USER at the first step S1410 of FIG. 11 may check the server 11 of the passenger and retrieve the health examination record of the passenger USER at a first step S1510.

At a second step S1520, the processor 170 may determine the passenger USER holds the chronic stress, based on that the server 11 is retrieved.

If the passenger is a chronic stress holder, the processor 170 verifies a chronic stress level at a third step S1530.

At the second step S1520 and the third step S1530, the server 11 may manage information about the presence of the chronic stress of the passenger USER and the chronic stress level, and the processor 170 may verify the chronic stress presence of the passenger USER and the chronic stress level simply by retrieving the server 11. Alternatively, the server 11 may manage health examination records of the passenger USER, and the processor 170 may deduce the chronic stress presence of the passenger USER and the chronic stress level by learning the health examination records.

At a fourth step S1540, the processor 170 may set the autonomous driving level according to the chronic stress level.

If the passenger USER is not a chronic stress holder, at a fifth step S1550, the processor 170 sets the autonomous driving level according to the selection of a passenger. In other words, at the fifth step S1550, the vehicle may be driven at “level0” which excludes the autonomous driving, or may be driven in any one mode among “level1” to “level5”.

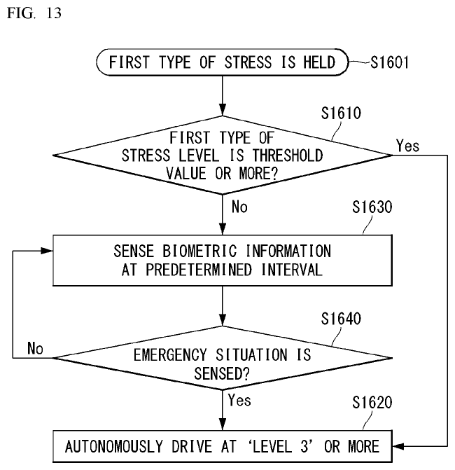

FIG. 13 is a flowchart illustrating an embodiment of setting the autonomous driving level according the chronic stress level.

Referring to FIG. 13, the processor 170 verifying that the passenger USER is the chronic stress holder at step S1601 determines whether the chronic stress level is a threshold value or more at a first step S1610. The threshold value may be set to a stress value that corresponds to a degree to which it is difficult for the passenger USER to actively intervene in driving.

If the chronic stress of the passenger USER is the threshold value or more, at a second step S1620, the processor 170 performs the autonomous driving at the “level 3” or higher. That is, this suppresses the passenger USER from actively intervening in driving while having an authority to monitor the driving.

If the chronic stress of the passenger USER is less than the threshold value, the third step S1630 senses biometric information at predetermined intervals during driving. At the third step S1630, the processor 170 may set the autonomous driving level according to the selection of the passenger USER.

At a fourth step S1640, the processor 170 sets the autonomous driving level to level3 or more, based on that an emergency situation is sensed. In other words, even if the passenger USER sets the autonomous driving level to level2 or less at the third step S1630, at the fourth step S1640, the processor 170 sets the autonomous driving level to level3 or more, for instance, level 3. The emergency situation refers to a situation in which a blood pressure, a degree of fatigue, a heart rate, electrocardiogram and the like exceed a safety range due to the chronic stress. The safety range refers to an extent to which the passenger USER may actively intervene in driving, and may be preset.

At the second step S1620 of FIG. 13, the autonomous driving level and the threshold value may vary depending on an embodiment. For example, in the case of decreasing the threshold value, the autonomous driving level may be set to level2. Furthermore, the autonomous driving level may be adjusted regardless of the threshold value. Moreover, the degree of the stress may be subdivided, and the autonomous driving level may be selected depending on the degree of the stress.

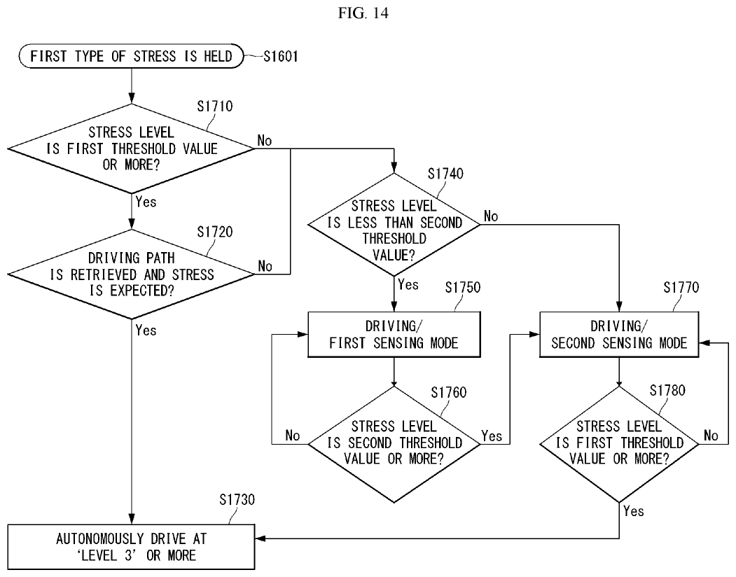

FIG. 14 is a flowchart illustrating another embodiment of controlling an autonomous driving mode.

Referring to FIG. 14, at step S1601, the processor 170 verifies that the passenger USER is the chronic stress holder. The step S1601 may be based on the determination of the second step S1520 shown in FIG. 12.

At a first step S1710, the processor 170 determines whether the stress level is the first threshold value or more. The first threshold value may correspond to the threshold value illustrated in FIG. 13. That is, the threshold value may be set to a stress value that corresponds to a degree to which it is difficult for the passenger USER to actively intervene in driving.

If the stress level of the passenger USER is the first threshold value or more, at a second step S17, the processor 170 retrieves a driving path, and expects the stress of the passenger USER on the basis of information about the driving path. The driving-path information may include a traffic volume on the driving path, the number of traffic lights, a noise level and the like. The processor 170 may learn the driving-path information and biometric information variance of the passenger USER or other passengers on an associated driving path, and may predict the biometric information variance of the passenger USER on the basis of the learned result. Moreover, the processor 170 may expect that the stress of the passenger USER will be induced when the predicted biometric information variance of the passenger USER exceeds a preset safety range. The procedure of expecting the stress of the passenger USER on the driving path may be performed by a traffic server as well as a vehicle.

When the stress of the passenger USER is expected on the basis of the driving-path information, at a third step S1730, the processor 170 performs the autonomous driving at level3 or higher.

If the stress of the passenger USER is less than the first threshold value or the stress of the passenger USER is not expected on the driving path, the stress level is compared with a second threshold value to select a stress mode at a fourth step S1740.

The second threshold value may be a value that is lower than the first threshold value, and may be set to an extent to which the passenger USER himself or herself may directly drive but it is necessary to sense the presence of the stress at a shorter interval.

If the stress level is less than the second threshold value, at a fifth step S1750, the processor 170 senses the stress in a first sensing mode.

The first sensing mode may include an electrocardiogram test, heart-rate measurement, blood-pressure measurement, and body-temperature measurement. In the first sensing mode, each test procedure may be carried out once, or performed at a relatively long time interval (e.g. one hour).

At a sixth step S1760 and a seventh step S1770, if the stress level is the second threshold value or more in a process of sensing the stress in the first sensing mode, the mode is converted into a second sensing mode. Furthermore, if it is determined at the fourth step S1740 that the stress level is the second threshold value or more, the processor 170 senses the stress in the second sensing mode.

The second sensing mode may include an electrocardiogram test, heart-rate measurement, blood-pressure measurement, and body-temperature measurement. In the second sensing mode, each test procedure may be performed at a shorter time intervals than that of the first sensing mode. For example, each test procedure may be performed every ten minutes.

At the fifth step S1750 and the seventh step S1770, the autonomous driving refers to a process of performing the autonomous driving as selected in a range from level0 to level5.

At an eighth step S1780, it is determined whether the stress level in the second sensing mode reaches the first threshold value. If the stress level in the second sensing mode is the first threshold value or more, the processor 170 sets the autonomous driving level to level 3 or higher.

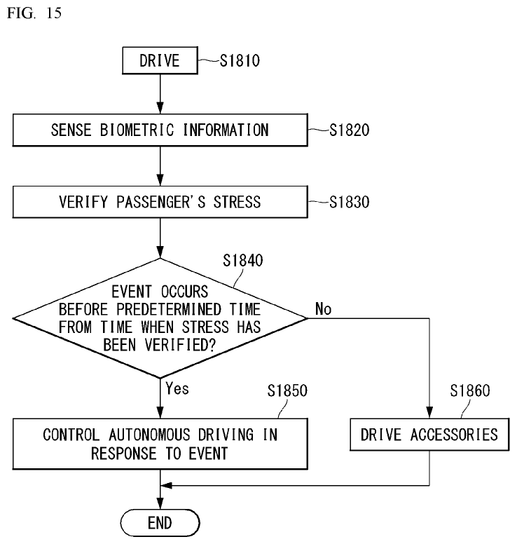

FIG. 15 is a flowchart illustrating an embodiment of controlling autonomous driving according to a stress cause.

Referring to FIG. 15, at a first step S1810, the vehicle performs autonomous driving at a level set according to the selection of the passenger USER.

At a second step S1820 and a third step S1830, the sensing unit 270 senses the biometric information, and the processor 170 verifies the stress of the passenger based on the biometric information.

At a fourth step S1840 and a fifth step S1850, the processor 170 controls the autonomous driving in response to an event, when the event occurs before a predetermined time from a time when the stress is verified.

If no event occurs before a predetermined time from a time when the stress is verified, accessories are driven at a sixth step S1860. The procedure of driving the accessories includes a step of driving an infortainment device that can alleviate the stress of the passenger USER. Alternatively, the procedure of driving the accessories may include a step of driving an air purifier, an air conditioner or a light in the vehicle and a step of adjusting a seat angle.

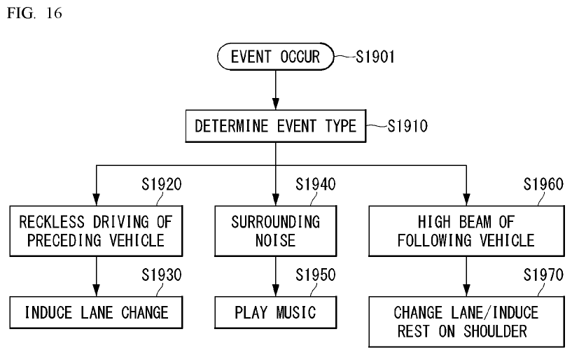

FIG. 16 is a diagram illustrating a specific embodiment of controlling autonomous driving according to an event occurrence.

Referring to FIG. 16, if the event occurs at step S1901, the processor determines the type of the event at a first step S1910. The event refers to something that may affect the stress of the passenger USER, and includes driving of surrounding vehicles, surrounding environment, noise, illuminance, and the like that are acquired through the sensing unit 270. The processor 170 may detect the event on the basis of the surrounding image of the vehicle, the noise and the like.

At a second step S1920 and a third step S1930, if the event is the reckless driving of a preceding vehicle, the processor 170 induces a lane change. The processor 170 may determine the reckless driving of the preceding vehicle, based on that the number of lane changes or sudden stops of the preceding vehicle is equal to or greater than a preset threshold value during a reference time. The lane-change induction may include a step of delivering a message recommending the passenger USER who is a driver to change a lane. Furthermore, the processor 170 may directly change a lane according to an autonomous driving level.

At a fourth step S1940 and a fifth step S1950, if the event is the surrounding noise, the processor 170 may play music by operating an infortainment device such as audio equipment of the vehicle. When the surrounding noise is the preset threshold value or more, the processor 170 may determine that the event is caused by the noise.

At a sixth step S1960 and a seventh step S1970, when the event is caused by a high beam or headlight of a following vehicle, the processor 170 may induce a lane change or induce the passenger USER to take a rest on a shoulder. When the rear illuminance of a host vehicle is a preset threshold value or more, the processor 170 may determine that the event is caused by the headlight of a following vehicle.

As described above with reference to FIG. 16, since the vehicle of the present disclosure identifies the cause of the stress and controls the autonomous driving and vehicle devices in response to the identified stress cause, it is possible to effectively cope with the stress of the passenger USER.

The object monitoring unit and the 3D modeling unit according to the above-described embodiment of the present disclosure may be embodied as a computer readable code on a medium on which a program is recorded. The computer readable medium includes all kinds of recording devices in which data that can be read by the computer system is stored. Examples of the computer readable medium include Hard Disk Drives (HDD), Solid State Disks (SSD), Silicon Disk Drives (SDD), ROMs, RAM,s CD-ROMs, magnetic tapes, floppy disks, optical data storages and others. Furthermore, the computer readable medium may be embodied in the form of a carrier wave (e.g. transmission via the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The above embodiments should be considered in all respects as exemplary and not restrictive. The scope of the present disclosure should be determined by reasonable interpretation of the appended claims and the present disclosure covers the modifications and variations of this disclosure that come within the scope of the appended claims and their equivalents.

What is claimed is:

1. An autonomous driving control method for controlling a driving mode on the basis of a result monitoring a passenger getting on a vehicle, the method comprising:
identifying the passenger by monitoring an interior of the vehicle;
verifying stress of the passenger by checking a stress history of the passenger or sensing biometric information of the passenger in real time, by a processor;
determining a cause of the stress by the processor, on the basis of the verified stress of the passenger; and
controlling an autonomous driving mode or an autonomous driving level of the vehicle, on the basis of the cause of the stress, by the processor.

2. The autonomous driving control method of claim 1, wherein the controlling of the autonomous driving mode selects any one of preset autonomous driving levels, based on that the passenger has a first type of stress verified in advance.

3. The autonomous driving control method of claim 2, wherein the selecting of the autonomous driving level sets the autonomous driving level to level 3 or more, based on that a stress value of the passenger is equal to or greater than a first threshold value.

4. The autonomous driving control method of claim 3, wherein the setting of the autonomous driving level to level 3 or more comprises:
retrieving information about an expected driving route by the processor;
predicting variance of the passenger's biometric information, based on learning variance of biometric information of the passenger or other passengers on the expected driving route; and
setting the autonomous driving level to level 3 or more by the processor, based on that the predicted variance of the biometric information exceeds a preset safety range.

5. The autonomous driving control method of claim 2, wherein the sensing of the biometric information controls a sensing unit by the processor at predetermined sensing interval while driving, based on that a stress level of the passenger is less than the preset first threshold value.

6. The autonomous driving control method of claim 5, wherein the controlling of the autonomous driving mode comprises:
verifying an emergency situation of the passenger by the processor, based on that the biometric information exceeds the preset safety range; and
setting the autonomous driving level to level 3 or more by the processor, on the basis of the emergency situation.

7. The autonomous driving control method of claim 5, wherein the sensing of the biometric information sets a sensing timing interval differently according to the stress level.

8. The autonomous driving control method of claim 1, wherein the verifying of the stress of the passenger comprises verifying a second type of stress of a driver by the processor, based on that the biometric information exceeds the preset safety range.

9. The autonomous driving control method of claim 8, wherein the controlling of the autonomous driving mode further comprises:
confirming by the processor, an event causing the second type of stress before a predetermined time from a time when the second type of stress occurs, on the basis of the verified second type of stress.

10. The autonomous driving control method of claim 9, wherein the controlling of the autonomous driving mode further comprises:
controlling a driving device to change a lane of a host vehicle by the processor, on the basis of the event in which a number of lane changes or sudden stops of a preceding vehicle is equal to or greater than a preset threshold value during a reference time.

11. The autonomous driving control method of claim 9, wherein the controlling of the autonomous driving mode further comprises:
controlling an audio system by the processor, on the basis of the event in which a surrounding noise of the host vehicle is equal to or greater than a preset threshold value.

12. The autonomous driving control method of claim 9, wherein the controlling of the autonomous driving mode further comprises:
controlling the driving device to change the lane of the host vehicle or stop on a shoulder by the processor, on the basis of the event in which an illuminance caused by a headlight of a vehicle following the host vehicle is equal to or greater than a preset threshold value.

13. An autonomous vehicle, comprising:
a driving device;
an autonomous driving system configured to control a portion or entirety of the driving device according to an autonomous driving level;
an object detection device configured to acquire a surrounding image;
a sensing unit configured to acquire biometric information of a passenger, a surrounding noise, an illuminance and the like; and
a processor configured to verify presence or absence of a passenger's stress on the basis of a server inquiry or the biometric information, and to control an autonomous driving mode on the basis of the passenger's stress.

14. The autonomous vehicle of claim 13, wherein the processor adjusts an autonomous driving level, based on that the passenger is a person having a first type of stress verified in advance.

15. The autonomous vehicle of claim 14, wherein the processor sets the autonomous driving level to level 3 or more, based on that a stress value of the passenger is equal to or greater than a first threshold value.

16. The autonomous vehicle of claim 15, wherein the processor retrieves information about a driving route based on that the stress value of the passenger is equal to or greater than the first threshold value, and sets the autonomous driving level to level 3 or more based on that the passenger's stress is expected on the driving route.

17. The autonomous vehicle of claim 14, wherein the processor senses the biometric information of the passenger, based on that a stress level of the passenger is less than a first threshold value, and sets the autonomous driving level to level 3 or more based on that the biometric information exceeds a preset safety range.

18. The autonomous vehicle of claim 13, wherein the processor verifies a second type of stress verified in real time based on that the biometric information of the passenger exceeds the preset safety range during driving, verifies an event causing acute stress before a predetermined time from a time based on that the second type of stress is verified, and sets the autonomous driving level in response to the event.
